(19) United States
(12) Patent Application Publication
(10) Pub. No.: US 2019/0166850 A1
(43) Pub. Date: Jun. 6, 2019

(54) CONVECTION OVEN

(71) Applicant: William BAILIE, White Rock (CA)

(72) Inventor: William BAILIE, White Rock (CA)

(21) Appl. No.: 16/324,840

(22) PCT Filed: Aug. 11, 2017
(86) PCT No.: PCT/CA2017/050955

§ 371 Date: Feb. 11, 2019

Related U.S. Application Data
(63) Continuation-in-part of application No. 15/234,977, filed on Aug. 11, 2016.

(51) Int. Cl. A21B 1/36

(52) U.S. Cl. CPC A21B 1/36

(57) ABSTRACT

An apparatus for cooking food articles comprises a casing having an interior having a plurality of cooking locations therein, a processor and a plurality of heat supply units adapted to provide a plurality of heated fluids to the interior of the casing wherein the processor is adapted to independently distribute the plurality of heated fluids to each of the plurality of cooking locations so as to not substantially effect adjacent cooking locations.

### BACKGROUND OF THE INVENTION

### 1. Field of Invention

The present invention relates generally to ovens and specifically to forced air convection ovens having multiple cooking chambers and arrangements.

### 2. Description of Related Art

A forced air convection oven heats objects, such as food, within the oven by transferring heat energy from a heat source to the objects by circulating a gas within the cooking cavity. Typically, the circulating gas is air, but other gases, such as steam, may also be used within the oven, depending upon the desired results. Commonly, a fan or blower is used to circulate the gas. Additionally, convection ovens often include radiant elements to supplement the heated gas.

Impinger ovens are a type of convection oven, and utilize jets to force pressurized hot gas onto the food within the oven. Impingement of hot gas onto the food increases cooking speed. Convection ovens may utilize a combination of hot gas circulation and impingement jets.

Typically, the cooking temperature of a convection oven chamber is controlled by detecting the temperature within the oven using sensors, and adjusting the gas flow and radiant elements as necessary. The temperature within the oven is impacted by cooling gradients around the food being cooked, and by the opening of oven doors.

It is desirable to control the moisture content within the oven cavity while cooking. When cooking at high temperatures, moist foods may not cook evenly when the moisture content within the oven is too high. Conversely, uneven cooking with overbrowning in spots may occur when the moisture content within the oven is too low. Automatic humidity controls are beneficial to ensure the optimal moisture levels within the cooking chamber.

Some previous convection oven designs have included a combination of radiant heating elements, blower and impingement jets to improve cooking efficiency, such as described in U.S. Pat. No. 2011/0276184 A1, McKee et al., and U.S. Pat. No. 4,829,158, Burnham. These designs incorporate just one cooking chamber and do not allow the option of adding hyper heat. Additionally, they do not incorporate combined heat and humidity control systems, or an included internal gas and or electric cooking system.

### SUMMARY OF THE INVENTION

According to a first embodiment of the present invention there is disclosed an apparatus for cooking food articles comprising a casing having an interior having a plurality of cooking locations therein, a processor and a plurality of heat supply units adapted to provide a plurality of heated fluids to the interior of the casing wherein the processor is adapted to independently distribute the plurality of heated fluids to each of the plurality of cooking locations so as to not substantially effect adjacent cooking locations.

The plurality of heat supply units may comprise a first heater adapted to output a first stage of heated air to the interior of the casing at a rate controlled by the processor, a second heater adapted to output a second stage of superheated air to the casing at a rate controlled by the processor and a steamer adapted to output a steam supply to the casing at a rate controlled by the processor. The air supply to the first heater may be drawn from the interior of the casing. The air supply to the second heater may be provided from the output of the first heater. The air supply to the steamer may be provided from the output of the second heater.

The output from the first heater may be divided into a first portion distributed into an interior of the casing and wherein the second portion is distributed into a plenum in a bottom of the casing. The second portion may be discharged from the plenum by a plurality of upwardly oriented nozzles. The apparatus may further include deflectors adapted to direct a portion of air discharged from the upwardly oriented nozzles to each of the plurality of cooking locations as determined by the processor. The first portion may be discharged from a plurality of supply columns through an opening adjacent to each of the plurality of cooking locations as determined by the processor.

The plurality of cooking locations may comprise a plurality of locations on a rack inside the interior of the casing. A portion of the superheated air may be distributed to each of a plurality of discharge nozzles oriented towards each of the cooking locations. A portion of the steam may be distributed to each of a plurality of discharge nozzles oriented towards each of the cooking locations. The processor may be adapted to select a proportion between 0 and 100% of each of the heated air, superheated air and the steam that is directed to each of the discharge nozzles. The plurality of discharge nozzles may be adapted to provide impingement cooking of a food article located in the cooking locations. Each of the discharge nozzles may be adapted to have their angle of impingement, pattern, rate and frequency of heated air, super-heated air and steam selectably adjusted.

The apparatus may further comprise a plurality of cooking elements locatable at each of the plurality of cooking locations. A portion of each of the heated air, the superheated air and the steam may be distributed to a plurality of output ports positioned to engage with each of the plurality of cooking elements. The apparatus may further comprise a gas outlet and an electrical outlet positioned to engage with each of the plurality of cooking elements. Each of the plurality of cooking elements may be adapted to utilize a combination of the heated air, superheated air, steam, electricity and gas to provide a cooking output to an adjacent zone as determined by the processor. Each of a top and bottom surface of each of the plurality of cooking elements may be adapted to provide a cooking output independently of each other. The apparatus may further comprise at least one steam nozzle directed towards each of the cooking locations. At least one of the plurality of cooking elements may include a plurality of protrusions adapted to space an article to be cooked apart therefrom. The plurality of protrusions may include a bore therethrough for discharging the heated air, the super-heated air and the steam into the article to be cooked as determined by the processor.

The interior of the casing may be divided into a plurality of chambers. The plurality of chambers may be selectably isolatable from each other by partition walls. The partition walls may include a fixed member having a plurality of apertures therethrough and a movable partition having a plurality of apertures therethrough selectably alignable with the apertures of the fixed member. Each of the plurality of cooking locations may have a unique associated access door providing access thereto independent of any other of the plurality of cooking locations. Each of the unique access door may include a plurality of nozzles along at least one edge thereof adapted to form an air curtain across the access door when the access door is open.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a front perspective view of a convection oven.

FIG. 2 is a rear perspective view of the convection oven of FIG. 1.

FIG. 3 is a top view of the convection oven of FIG. 1.

FIG. 4 is a cross sectional view of the convection oven of FIG. 3, taken along the line 4-4.

FIG. 5 is a schematic diagram of the piping layout of a convection oven of FIG. 1.

FIG. 6 is a perspective view of a recirculating air supply column of the convection oven of FIG. 1.

FIG. 7 is a perspective view of a spiralator nozzle for use in the convection oven of FIG. 1.

FIG. 8 is a schematic of a control system for use in the convection oven of FIG. 1.

FIG. 9 is a perspective view of an oscillator nozzle for use in the convection oven of FIG. 1.

FIG. 10 is a side view of a cooking element for use in the convection oven of FIG. 1 having a plurality of cooking surface types.

FIG. 11 is a perspective view of one of the service doors of the convection oven of FIG. 1.

FIG. 12 is a perspective view of one of the service doors of the convention oven of FIG. 1 according to a further embodiment of the present invention.

### DETAILED DESCRIPTION

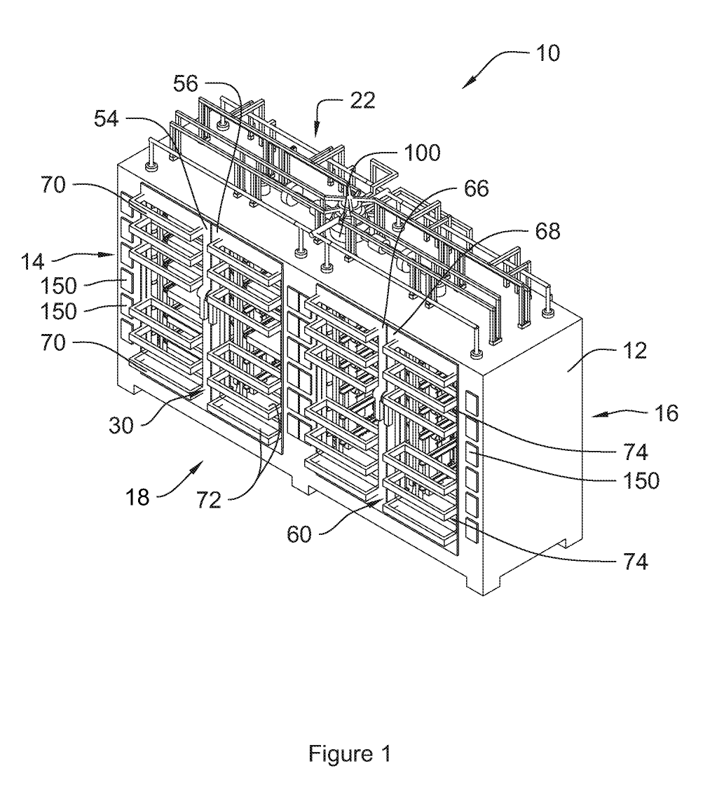

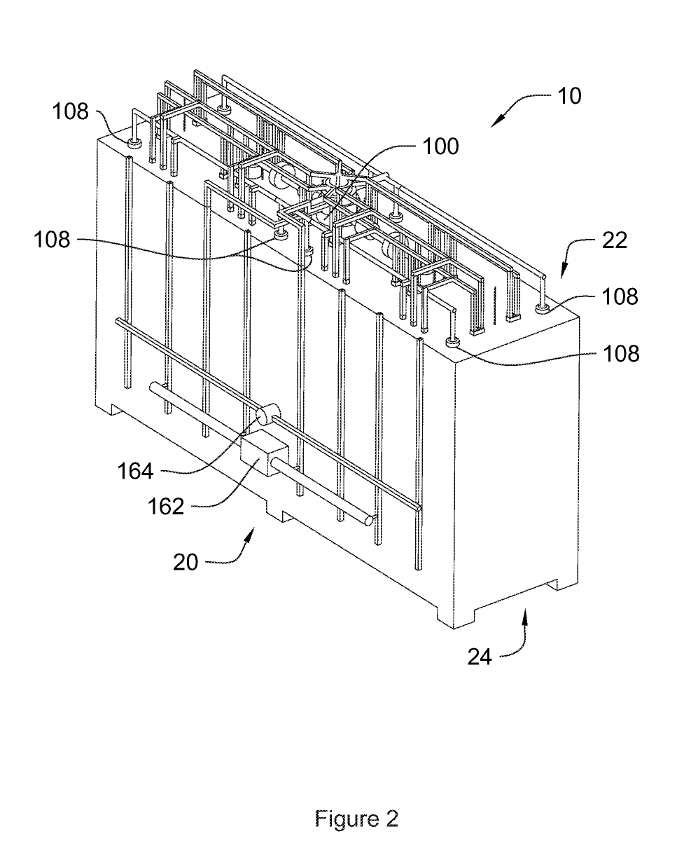

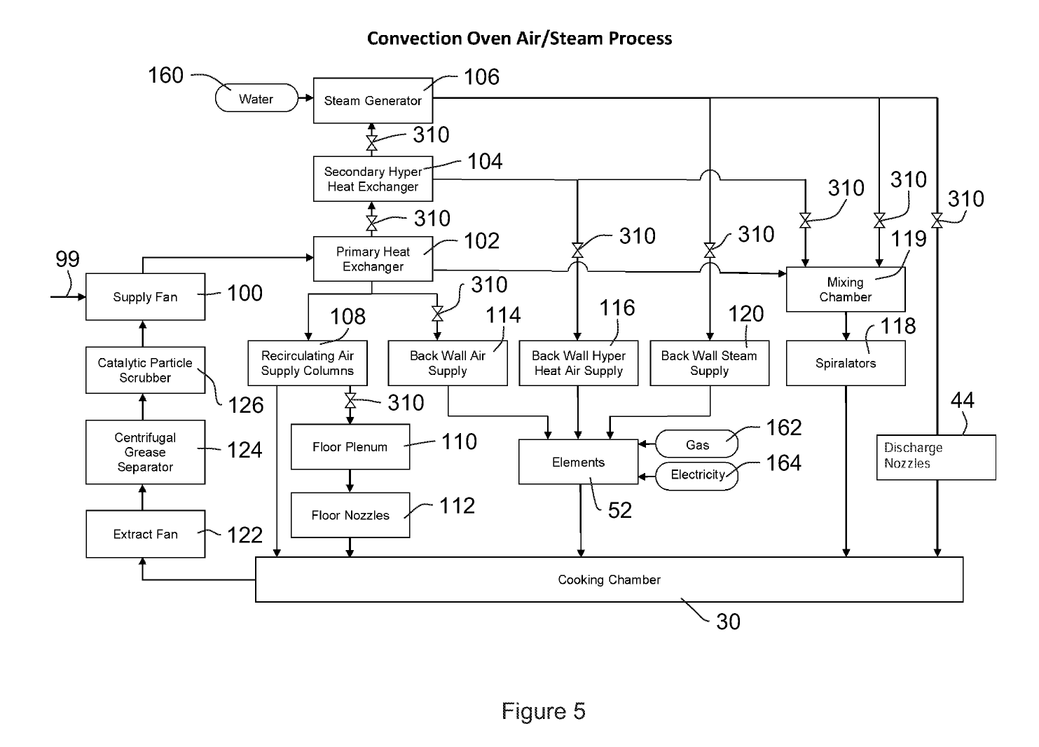

Referring to FIGS. 1 and 2, a convection oven according to a first embodiment of the invention is shown generally at 10. The oven 10 utilizes a recirculating heat and steam generation system, as illustrated in FIG. 5, to heat one or more modular cooking chambers and cooking locations contained therein in a variety of configurations, as will be described in more detail below.

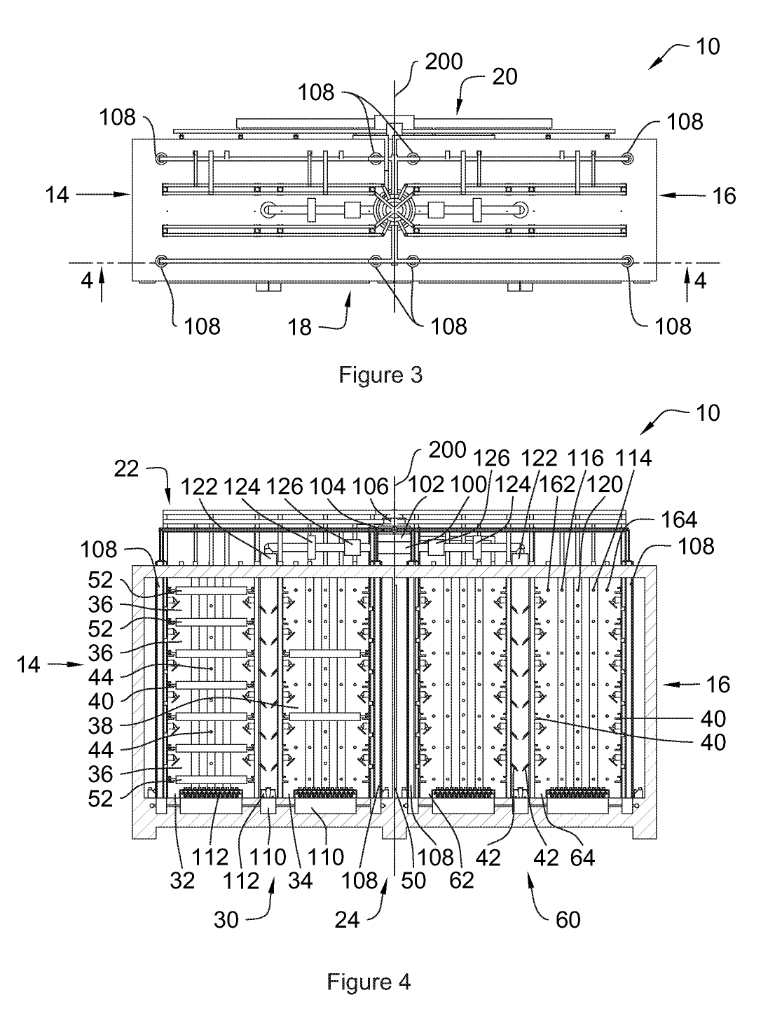

Referring to FIGS. 1 through 4, the oven 10 comprises a body 12 extending between left side 14 and right side 16, between front 18 and back 20, and between top 22 and bottom 24. The body 12 is divided into two chambers, first and second cooking chambers, 30 and 60, respectively. The first cooking chamber 30 extends substantially between the left side 14 and the centre plane 200. The second cooking chamber 60 extends substantially between the right side 16 and the centre plane 200. A sliding vane wall 50, located at the centre plane 200, separates the first and second cooking chambers 30 and 60. When the wall 50 is in place, the oven 10 is separated into two cooking chambers, 30 and 60, as indicated. The wall 50 may be opened to operate the oven 10 as one large chamber. When the wall 50 is closed, it may be possible to deactivate one cooking chamber and utilize the other chamber on its own, thereby improving efficiency and reducing energy usage or creating two different cooking environments using one cooking source. Although the present embodiment of the invention illustrates two cooking chambers, it may be appreciated that more chambers may be beneficial, as well.

A plurality of adjustable cooking locations may be located within each cooking chamber 30 and 60. As best seen on FIG. 4, the first cooking chamber 30 comprises first and second cooking zones, 32 and 34 respectively. The second cooking chamber 60 comprises third and fourth cooking zones, 62 and 64, respectively. The cooking zones may be further divided into a plurality of cooking locations by inserting elements 52 therein, as will be described in more detail below. As illustrated in FIG. 4, a plurality of racks 40 are distributed on either side of each cooking zone, 32, 34, 62 and 64. A plurality of elements 52 may be inserted into the cooking chambers such that they are supported by the removable racks 40. As illustrated, each rack may define a cooking zone although it will be appreciated that two zones may include a single rack spanning thereacross. Each of the cooking zones may be adapted to have an adjustable size by adjusting the size of the rack or by adjusting the size of the elements included therebetween as will be more fully described below. In particular, as illustrated in FIG. 4, the first cooking zone 32 is illustrated with a plurality of small sized cooking locations 36 and the second cooking zone 34 is illustrated with a plurality of medium sized cooking locations 38. Both the third and fourth second cooking zones, 62 and 64, respectively, are illustrated as large cooking locations, without any elements 52 therein. It may be appreciated that each cooking zone, 32, 34, 62 and 64, may be divided into a variety of cooking location size combinations, by adjusting the number of elements 52 therein. In the present illustrated embodiment of the invention, each left and right cooking chamber may be divided into up to six cooking locations, for a total of twenty-four possible small sized cooking locations in the oven 10. It may be appreciated that more or less elements may be useful, as well. It may be appreciated that the elements 52 may be larger or smaller than illustrated. By removing the removable racks 40 from the centre of a cooking chamber, a double-width element could be accommodated within the oven. It will also be appreciated that other combinations of larger or smaller elements may be utilized by adjusting the size and spacing of the racks to provide the cooking location sizes desired by a user.

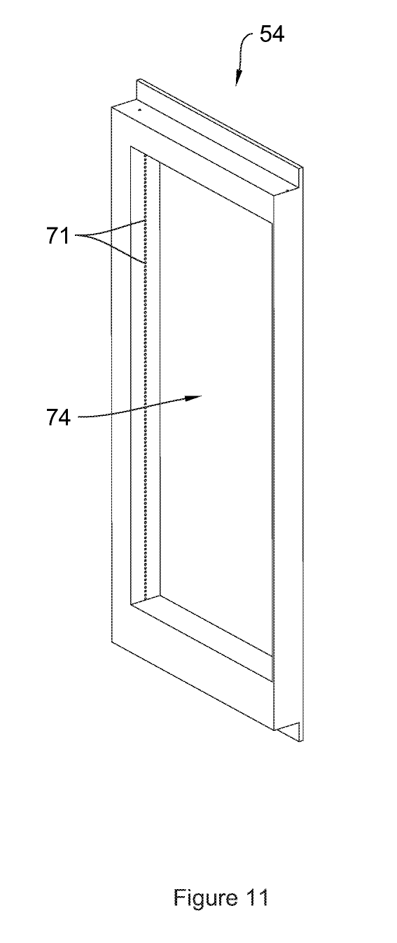

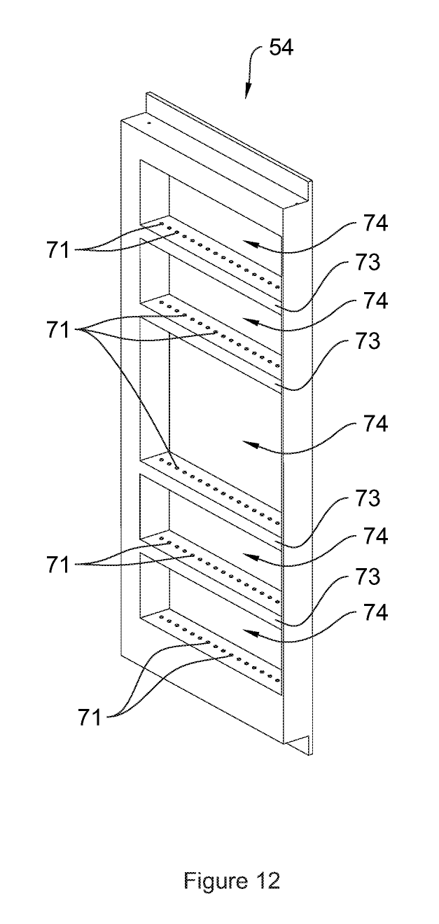

As best seen on FIG. 1, each cooking chamber, 30 and 60, may be accessed by either service doors or access doors. First cooking zone 32 may be accessed by a first service door 54. Second cooking zone 34 may be accessed by second service door 56. Third cooking zone 62 may be accessed by a third service door 66. Fourth cooking zone 64 may be accessed by a fourth service door 68. Door details such as hinge type, door handle and locking method may be designed with any method as is commonly known in the art. Each service door, 54, 56, 66 and 68, may include a plurality of identical access doors 70. Each access door 70 includes an window 72 and permits access to each small cooking area without the need to open the larger service doors, 54, 56, 66 and 68, to insert and remove items to be cooked. In particular each access door 70 may be supported and rotated on geared pins so as to present a frameless seal between each door. Rotation about such pins may be powered or unpowered. As illustrated in FIG. 11, each service door 54, 56, 66 and 68 may include a plurality of air nozzles 71 located along a side thereof at a position adapted to be covered or uncovered by the access doors so as to project an air curtain across the opening when an access door 70 is opened. As illustrated in FIG. 1, each service door, 54, 56, 66 and 68, includes 6 access doors 70, although it may be appreciated that more or less access doors may be useful, as well. Each access door 70, as seen in FIG. 1 may be opened rotationally on as set out above. In the present embodiment of the invention, as seen on FIG. 1, the top three access doors 70 on each service door pivot upwards, while the bottom three access doors on each service door pivot downwards, to allow a larger opening between the middle access doors on each service door. It may be appreciated that other hinge configurations and door quantities may be utilized, as well. Each access door 70 is contained within an access port 74 which as illustrated may comprise a common access port for all the doors within each service door. Each access port may include a plurality of air curtain nozzles which are activated when such access door is opened, such that an air curtain restricts the amount of heat that may escape from the oven 10, thereby increasing oven efficiency. Optionally, each service door 54, 56, 66 and 68 may include dividers 99 extending thereacross to separate the service door into a plurality of access ports 74 as illustrated in FIG. 12. The dividers may hingedly support the access doors 70 as is commonly known and may also include the air nozzles on one or both of the top and bottom of each access port 74 so as to be uncovered by the opening of that corresponding access door 70. It will be appreciated that the air nozzles 71 may be located on one or both of the top and bottom. As illustrated in FIG. 1, the access doors 70 at the top of each service door may open in an direction and the access doors 70 at the bottom ay open in a downward direction wherein the divider 99 in the middle of the access port 74 may be omitted as illustrated in FIG. 12 so as to create a larger access port 74 between the two middlemost access doors 70.

Turning to FIG. 5, the recirculating air/steam process for the oven 10 is illustrated in a schematic diagram. The process is shown for the first cooking chamber 30, although it may be appreciated that the same process may be applicable for one or more cooking chambers, with some key components utilized for both chambers. The supply fan 100 moves the air into the primary heat exchanger 102 where the air is heated to the desired temperature, which may be in a range such as, by way of non-limiting example, 500 to 700 degrees Fahrenheit, as set by the control system, as will be described below. From the primary heat exchanger 102 the heated air may be further heated by the secondary hyper heat exchanger 104, which will be described in more detail below, or it may continue through distribution pipes to a plurality of recirculating air supply columns 108, as will be described in more detail below, and optionally to a plurality of back wall air supply locations 114 to heat elements 52, as seen on FIG. 4. The air supply columns 108 supply heated air to individual cooking locations within the first cooking chamber 30 from the four corners of the first cooking chamber 30 and to the floor plenum 110, as will be described in more detail below. The floor plenum 110 supplies heated air to a plurality of interchangeable floor nozzles 112, which may be distributed in any configuration on the floor of the cooking chamber 30. The floor nozzles 112 are adjustable both for direction and flow rate therethrough, as is commonly known.

It will be appreciated that the floor nozzles 112 may be controlled or adjusted independently or in any grouping as desired. As seen on FIG. 4, a plurality of deflectors 42 within the cooking chamber deflect the heated air from the nozzles 112 to each individual cooking locations further distribute the heated air within the cooking chamber. All components supplied from the primary heat exchanger 102, including the air supply columns 108, the elements 52, independent rotary heads, as set out below, and the floor nozzles 112, expel the heated air into the first cooking chamber 30.

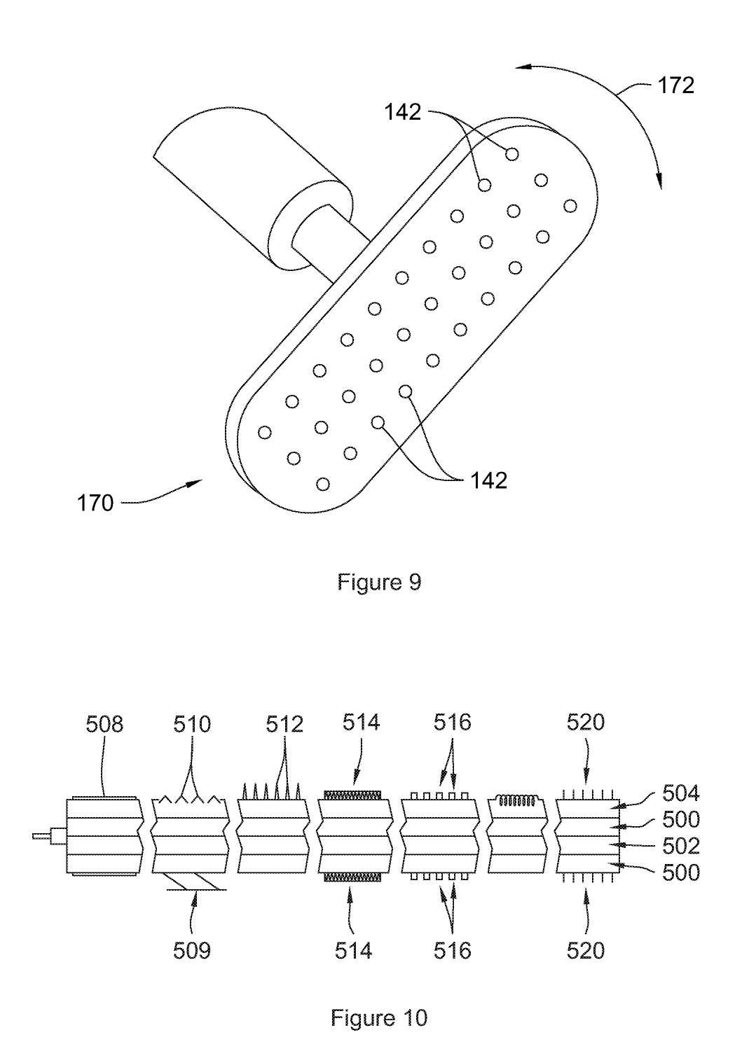

The secondary hyper heat exchanger 104, superheats the air, which may be in a range such as, by way of non-limiting example, 800 to 1000 degrees Fahrenheit, as set by the control system, as will be described below. The superheated air may continue through distribution pipes optionally to a plurality of individually controlled back wall hyper heat air supply locations 116 to heat elements 52. Also optionally, the superheated air may be supplied to a plurality of mixing chambers 119, as will be described in more detail below, which supply a plurality of discharge nozzles 118, as shown in FIG. 7, which will be described in more detail below. Alternately, the independent rotary heads may comprise stationary direct spray nozzles with adjustable pattern control, or moving oscillators 170 adapted to oscillate back and forth in a direction generally indicated at 172, as shown in FIG. 9. It will be appreciated that the oscillators are illustrated in FIG. 9 as moving in the direction indicated as well as along different oscillating directions through mounting upon gimbals or the like. The superheated air may also continue from the secondary hyper heat exchanger 104 to the steam generator 106. All components supplied by the secondary hyper heat exchanger 104, including the elements 52 and the spiralators 118, expel the superheated air into the first cooking chamber 30.

The steam generator 106 utilizes the superheated air to produce steam from a water supply source 160 which is introduced into the system through the back wall steam ports 44 as set out above. From the steam generator 106, the steam may continue through distribution pipes and mixed with additional superheated air from the secondary hyper heat exchanger 104 optionally within a plurality of individual mixing chambers 119 to the plurality of spiralators 118. The spiralators 118 may be supplied either directly with heated air from the primary heat exchanger 102, superheated air from the hyper heat exchanger 104, steam from the steam generator 106, as described above, or with a mixture of heated air from the primary heat exchanger 102 superheated air from the hyper heat exchanger 104 and steam from the steam generator 106. As shown on FIG. 5, the steam, heated air and superheated air may be mixed within a mixing chamber 119 prior to the spiralators 118 or, alternately, they may be mixed directly within the spiralators 118. In the current embodiment of the invention, each spiralator 118 is preceded by an independent mixing chamber 119, and each mixing chamber 119 is independently controllable by the control system, such that each spiralator may deliver the desired mixture of steam and superheated air, independent of other spiralators within the oven. Also optionally, the steam may be supplied to a plurality of back wall steam supply locations 120 to heat elements 52. Also optionally, the steam may be supplied to a plurality of back wall steam ports 44, as seen on FIG. 4, to supply steam directly into the cooking chamber 30. All components supplied by the steam generator 106, including the spiralators 118, the elements 52, and the steam ports 44 expel the steam into the first cooking chamber 30.

The combined air and steam within the cooking chamber 30 is drawn out of the chamber 30 with an extract fan 122. As seen in FIG. 4, each cooking chamber, 30 and 60, includes an extract fan 122 proximate to the top 22 of the oven 10. The extract fan 122 moves the air and steam to a centrifugal grease separator 124 and subsequently to a catalytic particle scrubber 126, from which the air is recirculated through the supply fan 100, and the process is repeated as described above. It will be appreciated that a make-up air supply 99 may also provide air to the supply fan 100 to replace any air released from or lost by the system during normal operation. The grease separator 124 and catalytic particle scrubber 126 may be selected as known in the art, and may be utilized to eliminate the need for an external exhaust system.

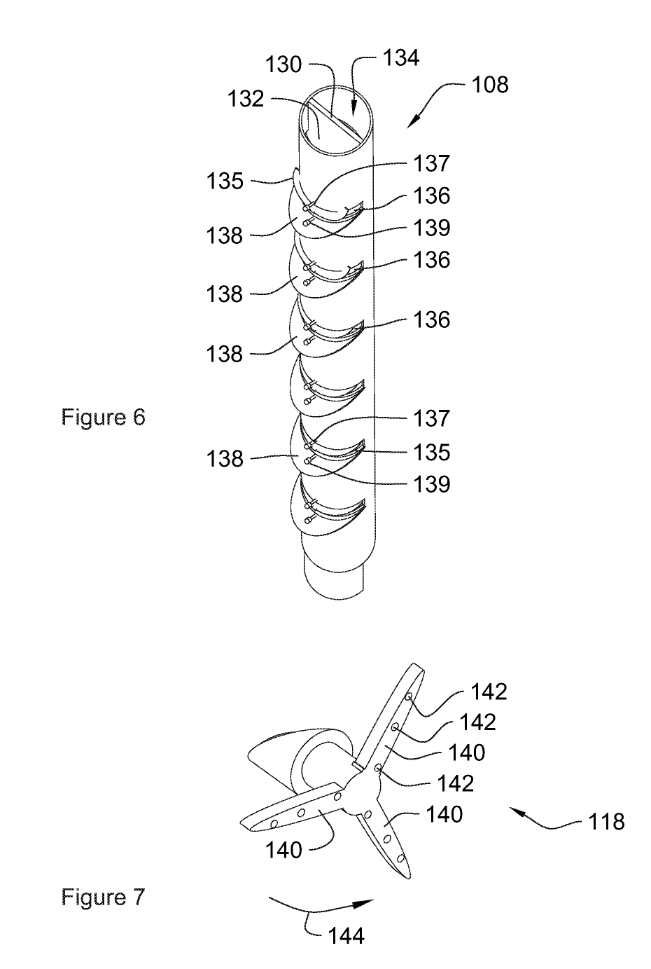

FIG. 6 illustrates the recirculating air supply columns 108. A recirculating air supply column 108 may be a hollow cylindrical shape, as illustrated, with a divider 130 therein to separate the heated airflow therethrough. It may be appreciated that other shapes may be useful, as well. The divider 130 provides two passages through the column 108, first passage 132 and second passage 134. The column 108 is formed with a plurality of openings 136 spaced therealong to allow the heated air within first passage 132 to exit the column 108 and enter the cooking chamber 30 at each individual cooking location. Each opening 136 is fitted with a balancing baffle 135 having a manual adjustor 137 which may be adjusted to balance the amount of heated air expelled from each opening 136. Each opening may also include a deflector 138 having a manual adjustor 139 such as a screw or the like to adjust the direction of the airflow leaving each opening. It will be appreciate that each deflector 138 may also include an actuator controlled by the processor to adjust the air directed to each cooking location or may optionally be pre-set to a predetermined position. The baffles and deflectors may be of any shape and size that is commonly known in the art. The second passage 134 connects to an opening in the floor of the cooking chamber 30 to supply heated air to the floor plenum 110. The floor plenum 110 may have a plurality of connected chambers, as illustrated in FIG. 4. The floor plenum 110 supplies a plurality of floor nozzles 112 that are adjustable for both flow and direction. The floor nozzles 112 may be distributed throughout the bottom of the cooking chamber 30 in any desirable configuration. As described above, a plurality of deflectors 42 within the cooking chamber 30 aid in distributing the heated air from the floor nozzles 112 within the cooking chamber 30 at each individual cooking location.

As described above, a plurality of elements 52 may be installed into the cooking chamber 30. The elements 52 may be attached by any suitable method, as known in the art. Each element is supported by a removable rack 40, as described above. Each element 52 may be heated with a selectable combination of heated air, superheated air, steam, gas provided heat or electrically provided heat. Gas is provided to each element 52 through a gas supply system 162 and electricity is provided by an electrical supply system 164, as is commonly known. Each element 52 may be controlled independently, such that each element 52 may be heated to an individually selected temperature via the control system. Additionally, each element 52 may provide a different type of heat, such as described above, from the top or bottom of each element 52, also controllable by the control system. It may be appreciated that multiple designs of elements 52 may be utilized such that they may be interchanged within the cooking area depending on the type of heating desired.

Turning now to FIG. 10, an element 52 is illustrated having a plurality of surface treatments and profiles for providing heat to a food article to be cooked thereabove or thereunder. As illustrated, the element may be formed with top and bottom plenums, 500 and 502, respectively adjacent to the interior of the element with top and bottom surfaces, 504 and 506, respectively thereover and thereunder. The top and bottom plenums 500 and 502 serve to distribute the heated air, superheated air and steam from the rear wall of the chambers throughout the element. The top and bottom surfaces 504 and 506 may be formed of or treated with a variety of materials selected for that particular cooking operation. By way of non-limiting example, the top and bottom surfaces 504 and 506 may be formed of and/or include therein, stones, ceramics metals or combinations thereof. The top and bottom surfaces 504 may also be solid or perforated to permit the heated air, hyper heated air and steam to pass therethrough or be contained as may be desired.

Each of the top and bottom surfaces may include one or more enhancement to assist with the heat delivery to the food article. By way of non-limiting example, the enhancements may comprise a griddle 508, platen 509 or induction element 518 which may be stationary or movable or grilling racks 510. It will be appreciated that the induction element may be electrically heated. Furthermore, pins 512 may be provided to support the food article above the top surface which may be solid or include passages therethrough to deliver heated air to the food article. Radiant or infrared heaters 514 may be provided on the top or bottom to provide a radiant heat to the food article from either the electrical or gas supplies as are commonly known. Needles 520 or nozzles 516 may also extend from the top and/or bottom surfaces to inject heat into or direct heat onto the food article. It will be appreciated that the needles and/or pins may be hollow to inject air and/or steam into the food and may optionally be heated by electricity, gas or the heated and/or steamed air. It will also be appreciated that each of the griddle 508, platen 509 grilling racks 510, pins 512, infrared heaters 514 nozzles 516 induction element 518 or needles 520 may include perforations through the top or bottom surface so as to permit the heated air, superheated air or steam within the top and bottom plenums 500 and 502 to escape therethrough which may come into contact with the food articles to assist cooking.

FIG. 7 illustrates a spiralator 118. A plurality of spiralators 118 may be distributed throughout the cooking chamber 30 as illustrated in FIG. 4. Each spiralator 118 may be a forced air impeller which includes a plurality of arms 140, each including a plurality of nozzles 142 sized and positioned to produce a spinning motion generally indicated at 144 when superheated air or steam is passed through the nozzles 142. It will also be appreciated that the spiralators 118 may be mounted on gimbals or the like to move in different rotations, direction or patterns. The spiralators 118 direct an automatically predetermined mixture of hot air and steam in a multi-spiral pattern directly onto the food items to be cooked. As described above, direct adjustable pattern spray nozzles, or oscillators as shown in FIG. 9, may be used in place of the spiralators 118. Accordingly, although spiralators and oscillators are illustrated, other movable and stationary spray pattern devices may be utilized as a discharge nozzle. It will also be appreciated that although the spiralators are illustrated as having three arms, a different number of arms or alternative configurations may also be utilized including disk shaped and that a different number, configuration, angle, arrangement and distribution of the nozzles may also be utilized. It will be appreciated that different sizes and patterns of nozzles 142 may be utilized to achieve different movement patterns for the independent rotary heads. Additionally, the nozzles 142 and/or the entire independent rotary head may be removable and replacable so as to permit an operator to customize the desired pattern and airflow at each cooking location.

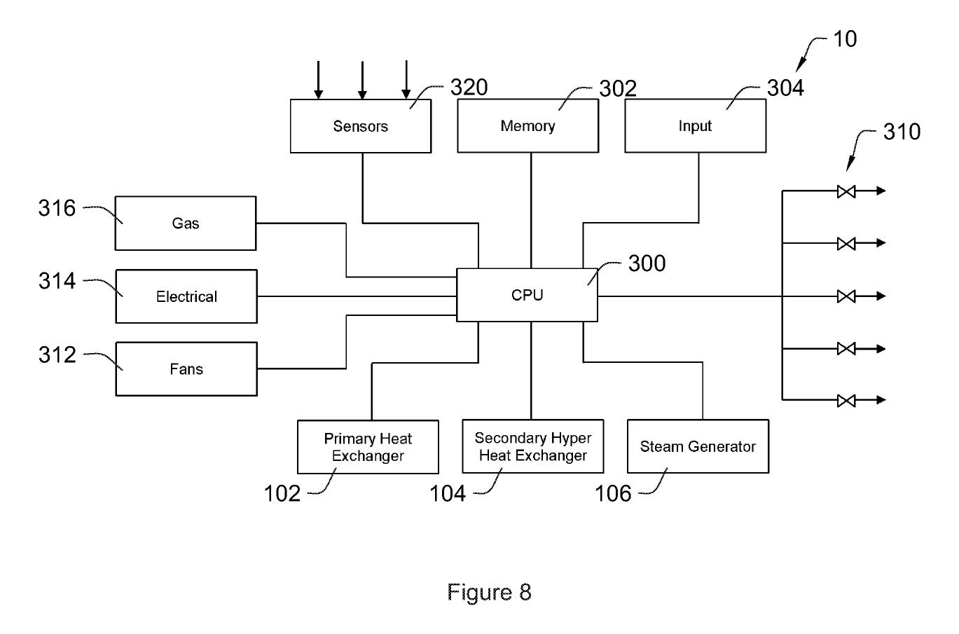

The oven 10 may be controlled through a plurality of touchscreen panels 150. Each touchscreen panel 150 may be used to select the desired heat and humidity within a small cooking area 36. Sensors 320 within the cooking locations, as illustrated on FIG. 8, provide information to the control panel to thereby control the heated air and steam supplied to each cooking area through the air supply columns 108, elements 52, spiralators 118, floor nozzles 112 and steam ports 44. A plurality of control valves 310, as illustrated in FIGS. 5 and 8, control the amount of heated air and steam supplied to each component. Sensors, control panels and control valves may be selected as known in the art. It will be appreciated that each of the elements, spiralators, nozzles and any heating distribution or control devices described herein and utilized by the present apparatus may be controlled independently or in groups so as to provide flexibility and customization for the different cooking processes desired.

With the ability to control the oven 10 using the selectable combination of heated air, superheated air, steam, electric heat or gas heat, each cooking location 36 may be operated at individually desired temperatures and humidity levels, thus allowing the user to cook a variety of different foods at the same time as well as optional high speed cooking, depending on the program selected.

Turning now to FIG. 8, the convection oven 10 includes a processor 300 for operating the convection oven as set out above, and a memory 302 that stores machine instructions that when executed by the processor 300 cause the processor 300 to perform one or more of the operations and methods described herein. Processor 300 may optionally contain a cache memory unit for temporary local storage of instructions, data, or computer addresses. For example, using instructions retrieved from memory 302, the processor 300 may control the reception and manipulation of input between a user input device 304 such as by way of non-limiting example, a key pad or touch screen and the valves generally indicated at 310 for controlling the operation of the oven 10. In various embodiments, the processor 300 can be implemented as a single-chip, multiple chips and/or other electrical components including one or more integrated circuits and printed circuit boards.

The processor 300 together with a suitable operating system may operate to execute instructions in the form of computer code and produce and use data. By way of example and not by way of limitation, the operating system may be Windows-based, Mac-based, or Unix or Linux-based, among other suitable operating systems. Operating systems are generally well known and will not be described in further detail here.

Memory 302 encompasses one or more storage mediums and generally provides a place to store computer code (e.g., software and/or firmware) and data that are used by the oven 10. It may comprise, for example, electronic, optical, magnetic, or any other storage or transmission device capable of providing the processor 300 with program instructions. Memory 302 may further include a floppy disk, CD-ROM, DVD, magnetic disk, memory chip, ASIC, FPGA, EEPROM, EPROM, flash memory, optical media, or any other suitable memory from which processor 300 can read instructions in computer programming languages.

Memory 302 may include various other tangible, non-transitory computer-readable media including Read-Only Memory (ROM) and/or Random-Access Memory (RAM). As is well known in the art, ROM acts to transfer data and instructions uni-directionally to the processor 300, and RAM is used typically to transfer data and instructions in a bi-directional manner. In the various embodiments disclosed herein, RAM includes computer program instructions that when executed by the processor 300 cause the processor 300 to execute the program instructions described in greater detail below. The memory 302 may further have installed within the device's memory, computer instructions as a program for executing the various cooking functions of the disclosure to carry out the methods of the embodiments disclosed herein.

While specific embodiments of the invention have been described and illustrated, such embodiments should be considered illustrative of the invention only and not as limiting the invention as construed in accordance with the accompanying claims.

What is claimed is:

1. An apparatus for cooking food articles comprising:
a casing having an interior having a plurality of cooking locations therein;
a processor;
a plurality of heat supply units adapted to provide a plurality of heated fluids to said interior of said casing;
wherein said processor is adapted to independently distribute said plurality of heated fluids to each of said plurality of cooking locations so as to not substantially effect adjacent cooking locations.

2. The apparatus of claim 1 wherein said plurality of heat supply units comprises:
a first heater adapted to output a first stage of heated air to said interior of said casing at a rate controlled by said processor;
a second heater adapted to output a second stage of superheated air to said casing at a rate controlled by said processor; and
a steamer adapted to output a steam supply to said casing at a rate controlled by said processor.

3. The apparatus of claim 2 wherein an air supply to said first heater is drawn from said interior of said casing.

4. The apparatus of claim 3 wherein an air supply to said second heater is provided from said output of said first heater.

5. The apparatus of claim 4 wherein an air supply to said steamer is provided from said output of said second heater.

6. The apparatus of claim 2 wherein said output from said first heater is divided into a first portion distributed into an interior of said casing and wherein said second portion is distributed into a plenum in a bottom of said casing.

7. The apparatus of claim 6 wherein said second portion is discharged from said plenum by a plurality of upwardly oriented nozzles.

8. The apparatus of claim 7 further including deflectors adapted to direct a portion of air discharged from said upwardly oriented nozzles to each of said plurality of cooking locations as determined by said processor.

9. The apparatus of claim 6 wherein said first portion is discharged from a plurality of supply columns through an opening adjacent to each of said plurality of cooking locations as determined by said processor.

10. The apparatus of claim 2 wherein said plurality of cooking locations comprises a plurality of locations on a rack inside said interior of said casing.

11. The apparatus of claim 10 wherein a portion of said superheated air and a portion of said steam are distributed to each of a plurality of discharge nozzles oriented towards each of said cooking locations.

12. The apparatus of claim 11 wherein said processor is adapted to select a proportion between 0 and 100% of each of said heated air, said superheated air and said steam that is directed to each of said discharge nozzles.

13. The apparatus of claim 11 wherein plurality of discharge nozzles are adapted to provide impingement cooking of a food article located in said cooking locations.

14. The apparatus of claim 13 wherein each of said discharge nozzles are adapted to have their angle of impingement, pattern, rate and frequency of heated air, super-heated air and steam selectably adjusted.

15. The apparatus of claim 2 further comprising a plurality of cooking elements locatable at each of said plurality of cooking locations.

16. The apparatus of claim 15 wherein a portion of each of said heated air, said superheated air and said steam is distributed to a plurality of output ports positioned to engage with each of said plurality of cooking elements.

17. The apparatus of claim 16 further comprising a gas outlet and an electrical outlet positioned to engage with each of said plurality of cooking elements.

18. The apparatus of claim 17 wherein each of said plurality of cooking elements are adapted to utilize a combination of said heated air, superheated air, steam, electricity and gas to provide a cooking output to an adjacent zone as determined by said processor.

19. The apparatus of claim 18 wherein each of a top and bottom surface of each of said plurality of cooking elements are adapted to provide a cooking output independently of each other.

20. The apparatus of claim 19 wherein at least one of said top and bottom surface of each of said plurality of cooking elements includes a plurality of apertures therethrough for passing said heated air, superheated air and steam introduced thereinto as determined by said processor.

21. The apparatus of claim 2 further comprising at least one steam nozzle directed towards each of said cooking locations.

22. The apparatus of claim 17 wherein at least one of said plurality of cooking elements includes a plurality of protrusions adapted to space an article to be cooked apart therefrom.

23. The apparatus of claim 22 wherein said plurality of protrusions includes a bore therethrough for discharging said heated air, said super-heated air and said steam into said article to be cooked as determined by said processor.

24. The apparatus of claim 2 wherein said interior of said casing is divided into a plurality of chambers.

25. The apparatus of claim 24 wherein said plurality of chambers are selectably isolatable from each other by partition walls.

26. The apparatus of claim 21 wherein said partition walls include a fixed member having a plurality of apertures therethrough and a movable partition having a plurality of apertures therethrough selectably alignable with said apertures of said fixed member.

27. The apparatus of claim 1 wherein each of said plurality of cooking locations has a unique associated access door providing access thereto independent of any other of said plurality of cooking locations.

28. The apparatus of claim 27 wherein each of said unique access door includes a plurality of nozzles along at least one edge thereof adapted to form an air curtain across said access door when said access door is open.
